(19) United States
(12) Patent Application Publication
(10) Pub. No.: US 2003/0116948 A1
(43) Pub. Date: Jun. 26, 2003

(54) Gas generator for a steering wheel airbag of a motor vehicle

(76) Inventors: Friedrich Back, Mullheim (DE); Markus Durre, Sulzberg (DE)

Correspondence Address: KENYON & KENYON, ONE BROADWAY, NEW YORK, NY, 10004, US

(21) Appl. No.: 10/026,081

(22) Filed: Dec. 21, 2001

(51) Int. Cl. B60R 21/16

(52) U.S. Cl. 280/731

(57) ABSTRACT

A gas generator having a filter tube for receiving a propellant filling for an airbag on the steering wheel of a motor vehicle, the gas generator being configured as a vibration absorber and being connected to the steering wheel by a gas-impermeable polymer spring element, which has the shape of a hollow truncated cone, and a flange, the connection(s) between the spring element (1), filter tube (3), and/or mounting flange (2) being configured as form-locking snap-on connection(s).

### BACKGROUND OF THE INVENTION

1. Field of the Invention

The present invention relates to a gas generator having a filter tube for receiving a propellant filling for an airbag on the steering wheel of a motor vehicle, the gas generator being configured as a vibration absorber and being joined to the steering wheel via a gas-impermeable, polymer spring element, having the shape of a hollow truncated cone, and a flange.

2. Description of Related Art

The vibrations that arise in motor vehicles during driving and also when standing still with the motor running can be transmitted to the steering column and from there to the steering wheel. To counteract these vibrations at the steering wheel and to improve driving comfort, vibration absorbers have become known in which the gas generator is used as an oscillating weight.

From European Patent 1 026 050, by way of example, a solution has become known in which the gas generator is supported in the airbag module by a mounting cylinder made of elastic material. The edges of the mounting cylinder are joined by vulcanization to the gas generator and to an installation plate. The gas generator for its part is enclosed by a mounting flange. This solution raises production-engineering problems.

### SUMMARY OF THE INVENTION

It is an object of the invention to create a gas generator that functions as a vibration absorber, that can be manufactured as simply as possible, and that can be easily installed on the steering wheel within the airbag module. It is a further object of the invention to provide such generator, wherein the propellant filling can be inserted into the filter tube without difficulty.

These and other objects of the invention are achieved through a gas generator of the type mentioned above wherein the connection(s) between spring element, filter tube, and/or mounting flange are configured as form-locking snap-on connection(s). In accordance with this teaching, it is possible first to manufacture the filter tube in a simple manner, to provide it with propellant filling, and then to insert it into the spring element as the gas generator. By appropriately configuring the filter tube, the spring element, and/or the mounting flange, the gas generator can easily be joined to the spring element and mounting flange, by locking it into corresponding snap-on connectors as snap fasteners. The heretofore customary connection of filter tube and spring element by vulcanization is made irrelevant.

### BRIEF DESCRIPTION OF THE DRAWINGS

The present invention will be described in greater detail with reference to the following drawings wherein:

FIG. 1 shows a side view of a filter tube, partially in a sectional view, having the spring element and the snap-on connections.

FIG. 2 shows detail x from FIG. 1 in an enlarged view.

FIG. 3 shows the filter tube according to FIG. 1 in a top view.

FIG. 4 shows a filter tube in a side view, having a different embodiment of the spring element.

FIG. 5 shows detail x from FIG. 4, enlarged.

FIG. 6 shows the filter tube in a side view, having a further, possible embodiment of the spring element.

FIG. 7 shows detail x from FIG. 6 in an enlarged version.

FIG. 8 shows a filter tube having an airbag spacer plate in a side view, partially in a sectional view.

FIG. 9 shows detail x from FIG. 8, enlarged.

### DETAILED DESCRIPTION OF THE INVENTION

The snap-on connection between filter tube and spring element can be generated as a result of the fact that the filter tube is provided on its exterior wall with a circumferential bulge, which can be generated, for example, by compressing the filter tube or by attaching an added-on protrusion (for example, a pressed-on flange). The spring element for its part is provided on at least one of its exterior edges with a thickened section, a groove for receiving the filter tube bulge and/or the mounting flange being introduced at least into one of these thickened sections. This is the simplest form of many possible configurations. The bulge of the filter tube is encircled by the one groove on the spring element, whereas the other groove of the spring element encompasses the mounting flange. Of course, a further, simplified embodiment is also possible, in which only the bulge of the filter tube is snapped into the groove of the spring element, whereas the other edge of the spring element is joined to the mounting flange by vulcanization. The vulcanization between spring element and mounting flange is relatively easy to carry out, in comparison to a vulcanization on the filter tube.

To achieve greater rigidity in the area of the snap-on connection, it is possible in at least one of the thickened sections to insert a reinforcement core of greater strength, made of metal or plastic. This reinforcement core is extrusion-coated in its entirety using the material of the spring element, so that it is protected against corrosion, if it is made of metal. As a result, a high aging-stability and temperature-insensitivity is achieved in the area of the snap-on connections.

In a further embodiment of the idea of the present invention, the thickened sections can be provided with a molded core on their edge side facing the bulge and/or the mounting flange, the molded core being furnished with the corresponding groove for the filter tube bulge and/or the mounting flange. This molded core can be made of metal, plastic, or a high-strength, aging- and temperature-insensitive polymer. Because a molded core of this type is generally not very flexible, it is expedient to provide it with a sliding bevel for inserting the filter tube into the spring element or for pressing the spring element onto the mounting flange. In an extreme case, these sliding bevels can be formed by flexible barbs.

To avoid damage to the airbag as a result of the vibrating gas generator, and so as not to block the vibrating gas generator, the gas generator in many cases is enclosed by an airbag spacer plate. In this context, the goal is that the airbag spacer plate encloses the gas generator in the center at the same distance. In accordance with a further step of the present invention, this central position of the airbag spacer plate can be assured as a result of the fact that the mounting flange on its inner edge is configured on the top side in a T-shape or an L-shape. The upward pointing edge of the cross beam on the T or on an L assures the centering of the airbag spacer plate.

In order to further reduce costs, it is possible to use the base plate of the airbag module as the mounting flange. In this case, the separate mounting flange may be omitted.

To avoid excessive vibrations in the gas generator, the thickened section for the filter-tube bulge on its radial exterior side can be provided with limit stoppers distributed uniformly over its circumference.

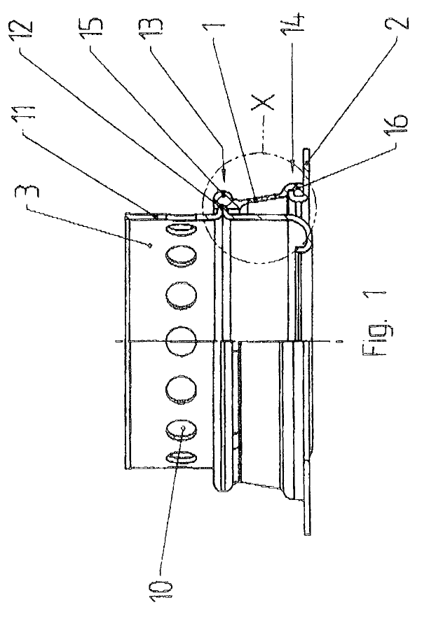

In FIG. 1, filter tube 3 is depicted, which is connected to mounting flange 2 by spring element 1. On the left side of the Figure, filter tube 3 having spring element 1 is depicted in a side view. The right side of the Figure shows filter tube 3 in a sectional view. A propellant filling, which is not shown in greater detail, is inserted into filter tube 3. Openings 10 are the gas-exit openings. Filter tube 3 on its exterior wall 11 is provided with circumferential bulge 12, which was generated in a compression process. Spring element 1 has the shape of a hollow truncated cone and is made of a gas-impermeable polymer material. At its exterior edges 13 and 14, it has thickened sections 15 and 16, which are provided with grooves 17 and 18, respectively. As a result of groove 17, spring element 1 encompasses bulge 12 of filter tube 3, and as a result of groove 18, it encompasses the bent edge of mounting flange 2. Bulge 12 and the edge of mounting flange 2, together with a groove is 17 and 18, respectively, produce the snap-on connections.

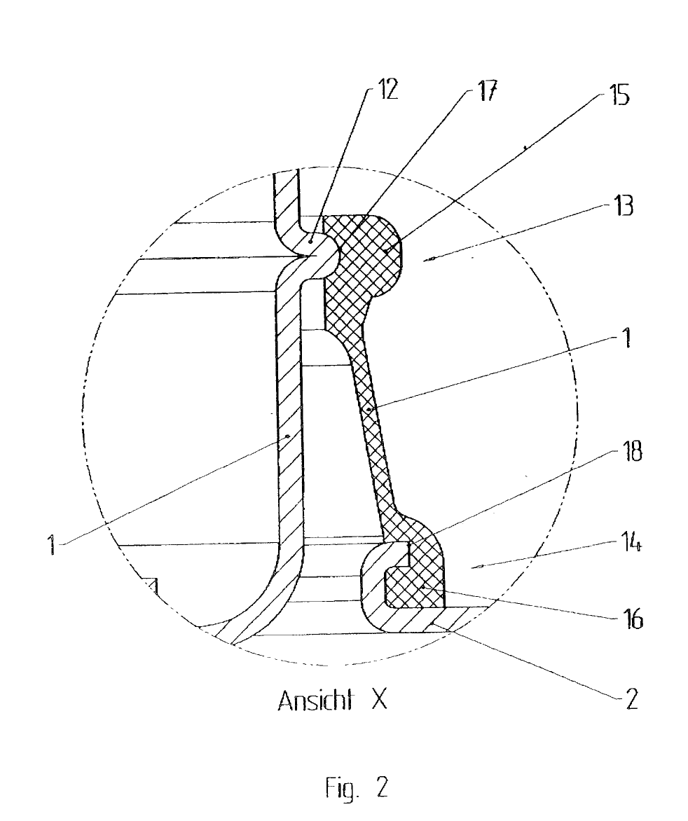

In FIG. 2, detail x from FIG. 1 is depicted in an enlargement. During assembly, spring element 1 is first joined to mounting flange 2, by pulling thickened section 16 having groove 18 over the edge of mounting flange 2. After mounting flange 2 having spring element 1 is inserted into the airbag module, filter tube 3, having the gas generator inserted therein, is pressed into spring element 1 in a simple manner, filter tube 3 then being arrested by its bulge 12 in groove 17 of upper edge 13 of spring element 1.

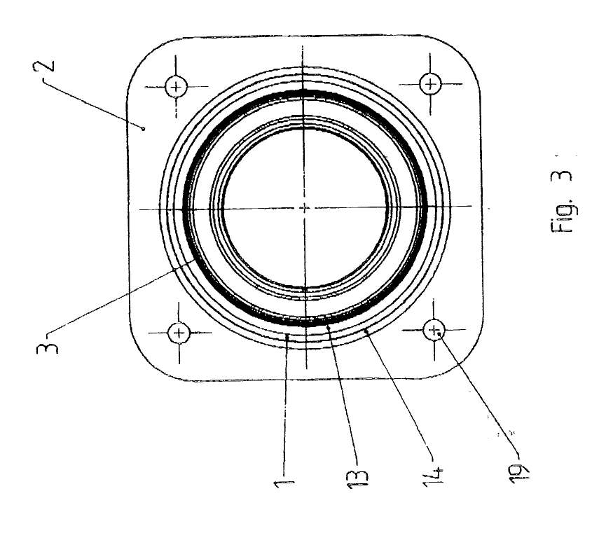

In FIG. 3, filter tube 3 having spring element 1 and mounting flange 2 is depicted in a top view. Mounting flange 2 is approximately square and provided with four holes 18 for inserting mounting screws.

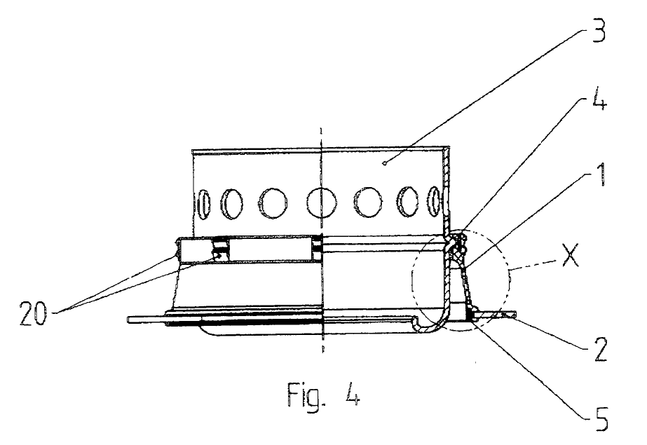

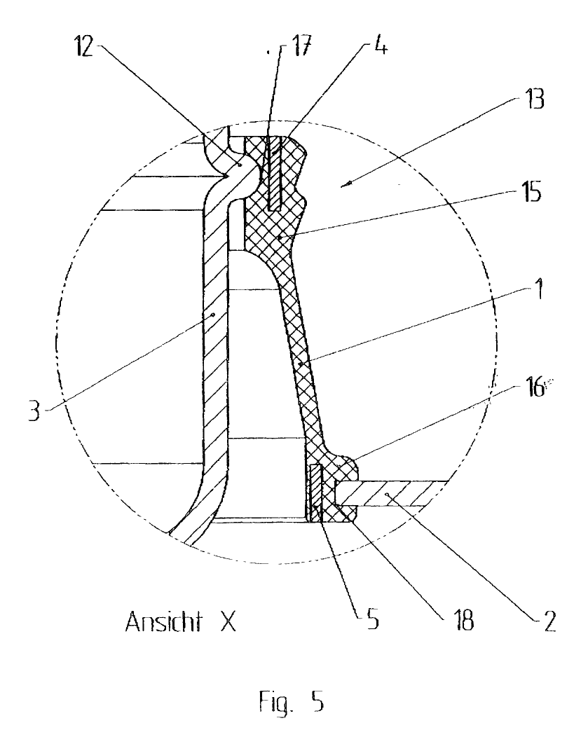

In FIGS. 4 and 5, filter tube 3 is also depicted in a side view, but in conjunction with a somewhat differently configured spring element 1. The interior edge of flange 2 is also configured in a slightly different manner. In this exemplary embodiment, thickened sections 15 and 16 in the area of the snap-on connections are provided with reinforcement cores 4 and 5, which are enclosed by the polymer material of spring element 1. These reinforcement cores 4 and 5 give spring element 1 increased strength in the area of the snap-on connections. Depending on the installation conditions, reinforcement cores 4 and 5 can be made of metal, plastic, or another appropriate material. The assembly of spring element 1 and mounting plate 2 occurs by snapping mounting plate 2 into groove 18 of spring element 1. Filter tube 3 is mounted in the same way, as is pictured already in FIG. 1, by pressing filter tube 3 having its bulge 12 into groove 17 of spring element 1. Thickened sections 15 at upper edge 13 of spring element 1 have on their radial exterior side a plurality of limit stoppers 20, that are uniformly distributed around the circumference.

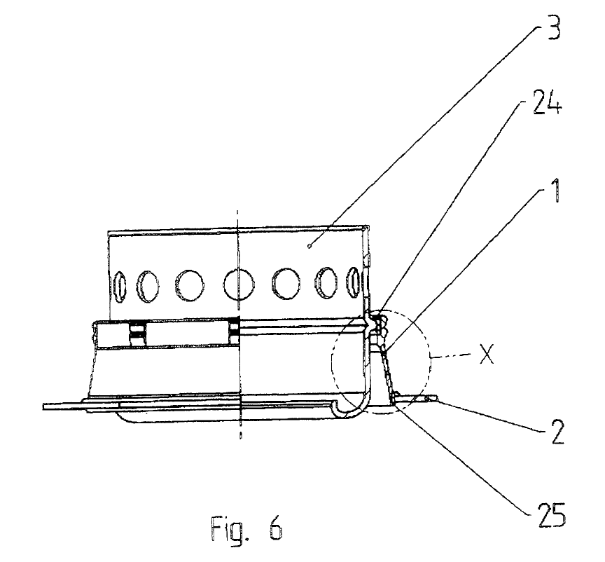

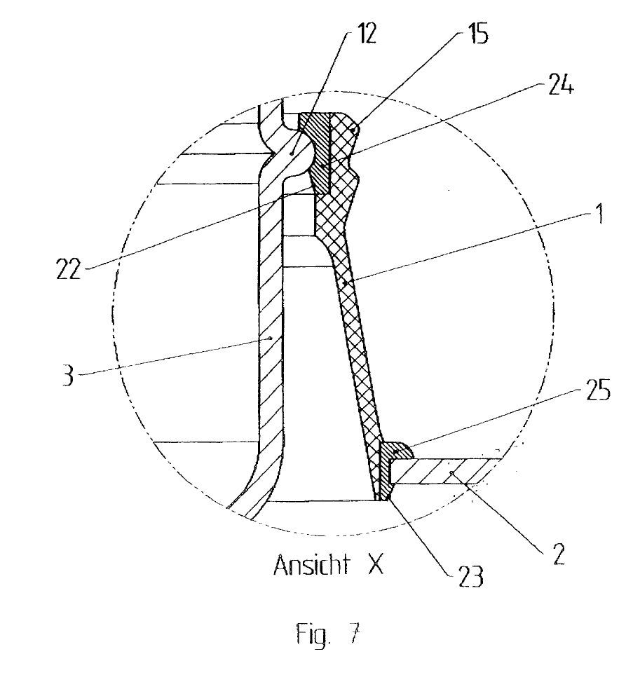

In FIGS. 6 and 7, an embodiment of filter tube 3 and spring element 1 is depicted that is comparable to FIGS. 4 and 5, with the difference that thickened sections 15 and 16 on their edge side facing bulge 12 and mounting flange 2 are provided with molded cores 24 and 25. Molded cores 24 and 25 have grooves 17 and 18 for being snapped on bulge 12 or on mounting flange 2. These molded cores 24 and 25 are made of a far less elastic material than spring element 1. To improve the snap-on capacity, molded cores 24 and 25 are provided with sliding bevels 22 and 23, which make it easier to push filter tube 3 into spring element 1, or to push spring element 1 onto mounting flange 2. In extreme cases, sliding bevels 22, 23 can be formed using flexible barbs. These barbs can be formed by recesses in molded cores 24 and 25.

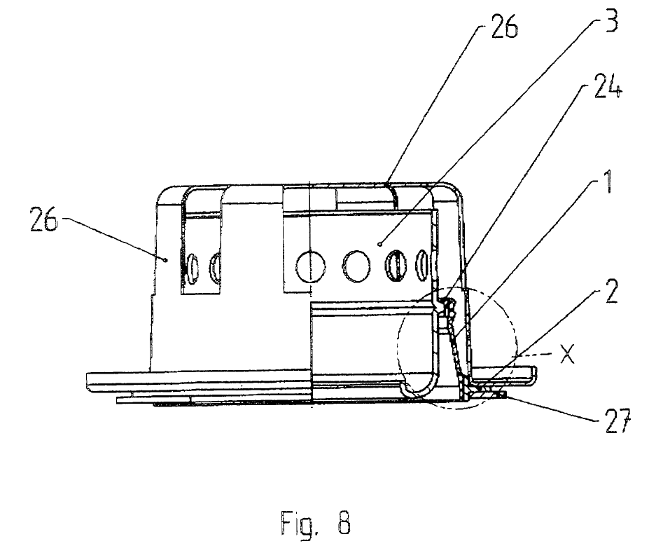

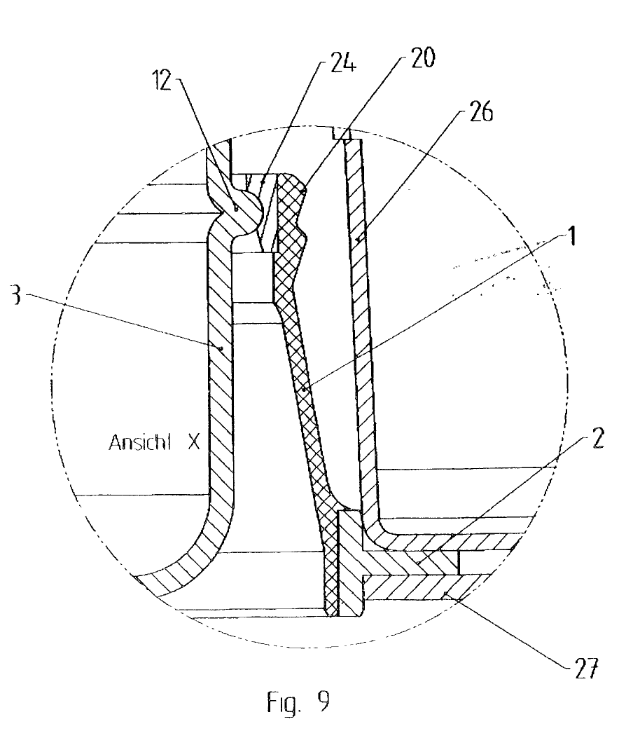

FIGS. 8 and 9 depict filter tube 3 having spring element 1, inserted into an airbag support plate 26. Spring element 1 at its upper edge is provided with molded core 24. Groove 17 of molded core 24 is engaged by bulge 12 of filter tube 3. The lower edge of spring element 1 is joined to mounting flange 2 by vulcanization. Mounting flange 2 towards its interior edge is configured in a T shape, as a result of which both flange 2 as well as airbag spacer plate 26 can be centrally oriented with respect to a base or lifting plate 27 and can be secured thereon. The airbag spacer plate at its lower edge contacts the upper bar of T-shaped mounting flange 2, whereas the latter is supported at its lower bar on base plate 27. In FIG. 9, it is clear that limit stopper 20, in response to a strong vibrating motion of filter tube 3, impacts airbag spacer plate 26, before filter tube 3 impacts spring element 1 in the area of mounting flange 2. In a continuation of the basic idea of the present invention, base plate 27 of the airbag module can be used here as mounting flange 2. In this case, base plate 27 takes on all of the aforementioned tasks of mounting flange 2, assuming that base plate 27 is configured appropriately.

In FIGS. 1 through 7, embodiments are depicted in which spring element 1 is connected via a snap-on connection both to mounting flange 2 as well as to filter tube 3. In the context of the basic idea of the present invention, however, all possibilities are open, because either the one or the other snap-on connection can be configured as an adhesive or vulcanization connection, as is depicted by way of example in FIGS. 8 and 9. Most importantly, the question here is of the connection between spring element 1 and mounting flange 2 as a vulcanization or adhesive connection.

What is claimed is:

1. A gas generator incuding a filter tube for receiving a propellant filling for an airbag on the steering wheel of a motor vehicle, the gas generator being configured as a vibration absorber and being connectable to the steering wheel by a gas-impermeable polymer spring element, which has the shape of a hollow truncated cone, and a flange, wherein at least one connection between spring element (1), filter tube (3), or mounting flange (2) is configured as a form-locking snap-on connection.

2. The gas generator according to claim 1, wherein the filter tube (3) on its exterior wall has a circumferential bulge (12).

3. The gas generator according to claim 2, wherein the bulge (12) is formed by compressing the filter tube (3) or by adding on a protrusion.

4. The gas generator according to claim 3, wherein the protrusion is a clinch flange.

5. The gas generator according to claim 1, wherein the spring element (1) on at least one of its exterior edges (13, 14) is provided with thickened sections (15, 16).

6. The gas generator according to claim 5, wherein at least one of the thickened sections (15, 16) has a groove (17, 18) for receiving the filter tube bulge (12) or the mounting flange (2).

7. The gas generator according to claim 6, wherein, in the area of the snap-on connection, a reinforcement core (4, 5) of greater strength, made of metal or plastic, is inserted into at least one of the thickened sections (15, 16).

8. The gas generator according to claim 6, wherein the thickened sections (15, 16) on their edge side facing the bulge (12) or the mounting flange (2) are provided with a molded core (24, 25), which is furnished with the groove (17, 18) for the filter tube bulge (12) or for the mounting flange (2).

9. The gas generator according to claim 8, wherein the molded core (24, 25) is made of metal, plastic, or a high-strength aging- and temperature-insensitive polymer.

10. The gas generator according to claim 8, wherein the molded core (24, 25) has sliding bevels (22, 23) for pushing the filter tube (3) into, or onto, the mounting flange (2).

11. The gas generator according to claim 10, wherein the sliding bevels (22, 23) are formed by flexible barbs.

12. The gas generator according to claim 1, wherein the gas generator is enclosed by an airbag spacer plate (26).

13. The gas generator according to claim 1, wherein the mounting flange (2) is configured at its interior edge towards the top as a T shape or an L shape.

14. The gas generator according to claim 1, wherein the base plate (27) of the airbag module is used as mounting flange (2).

15. The gas generator according to claim 1, wherein the thickened section (13) around the filter-tube bulge (12) is provided on its radial exterior side with limit stoppers (20) that are uniformly distributed around the circumference.
